(19) United States
(12) Patent Application Publication
(10) Pub. No.: US 2010/0100560 A1
(43) Pub. Date: Apr. 22, 2010

(54) LEARNING ANATOMY DEPENDENT VIEWING PARAMETERS ON MEDICAL VIEWING WORKSTATIONS

(75) Inventors: Daniel Bystrov, Hamburg (DE); Stewart Young, Hamburg (DE); Vladimir Pekar, Toronto (CA); Christian Adrian Cocosco, Hamburg (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/531,695

(22) PCT Filed: Mar. 28, 2008
(86) PCT No.: PCT/IB08/51166

§ 371 Date: Sep. 17, 2009

(30) Foreign Application Priority Data
Mar. 30, 2007 (EP) 07105290.6

(51) Int. Cl. G06F 17/30; G06F 3/048

(52) U.S. Cl. 707/769; 715/764; 707/E17.014; 707/758

(57) ABSTRACT

The invention relates to a data processing apparatus and a method for providing visualisation parameters controlling the display of a medical image (12). The data processing apparatus comprises a mapping component (16). The mapping component (16) is arranged to receive a current dataset (15) corresponding to the medical image and comprising a content description thereof, to compare the content description of the current dataset (15) with a content description of a plurality of stored datasets, to select at least one further dataset out of the plurality of stored datasets, to retrieve stored visualisation parameters corresponding to the at least one further dataset, and to prepare the retrieved visualisation parameters as the visualisation parameters controlling the display of the medical image (12).

### FIELD OF THE INVENTION

The invention relates to a data processing apparatus for providing visualisation parameters controlling the display of a medical image.

The invention further relates to a method of providing visualisation parameters controlling the display of a medical image. The invention still further relates to a computer program product.

### BACKGROUND OF THE INVENTION

It is known from international patent application WO 2006/013499 to analyze a medical image with respect to a spatial position and orientation of an object shown in the medical image. The result of the analysis is used in order to define the parameters of the scan geometry for a new scan of the same object. Typically, the new scan is performed at a higher resolution or other modified settings of the scan process compared to the first scan. As such, the first scan is often referred to as a scout scan. Automated scan planning enables fully automated acquisition of medical data sets of MRI (Magnetic Resonance Imaging) systems. This functionality is based on two major technologies: first, the automated detection of an anatomical landmark in survey images and, secondly, the analysis of these landmarks with respect to the subsequent scanning geometry manually planned by an operator. This ensures a consistent acquisition of corresponding objects, such as a certain organ of the human body. For example, a four-chamber view of the heart will always be acquired using substantially the same anatomy dependent scan geometry, regardless of whether it is the heart of two different patients or whether the two scans are separated by a (long) time period. Assuring a consistent scan geometry for a specific object facilitates comparison of two or even a large number of scans, both intra-patient and inter-patient.

However, it is not known in the prior art to display a medical image in a consistent way that depends on the object shown in the image and in a preferred manner for displaying this kind of medical image. Manual adjustments of the visualisation parameters that govern the manner in which the image is displayed need to be performed by a user of a medical viewing work station, thus requiring the user's time and attention. Manual adjustments may vary from one user to another and/or from one session to another. This makes a comparison or analysis of medical images difficult. Moreover, manual adjustments may be a potential source of error leading to a misinterpretation of the medical image.

### SUMMARY OF THE INVENTION

The present invention addresses these and other problems in the prior art by providing a data processing apparatus for providing visualisation parameters controlling the display of a medical image. The data processing apparatus comprises a mapping component that is arranged to receive a current data set corresponding to the medical image and comprising a content description thereof, to compare the content description of the current data set with a content description of a plurality of stored data sets, to select at least one further data set out of the plurality of stored data sets, to retrieve stored visualisation parameters corresponding to the at least one further data set and to prepare the retrieved visualisation parameters as the visualisation parameters controlling the display of the medical image.

The data processing apparatus may be implemented in hardware or in software or as a combined hardware/software solution. When implemented at least partly in software, the different functionalities may be performed by different modules, classes or other entities that are known in software engineering. In an analogue manner the same applies to a solution that is at least partly implemented in hardware.

The correspondence between a data set and a medical image may be implemented in various ways. For example the data set could be comprised in the image as tag data, or attached to the image in a similar manner. Alternatively, the data set could be referred to by such tag data or the name of the image. A reference to the data set and a reference to the medical image could also be stored in a data base that defines the correspondences and relationships between a number of data sets and images, respectively.

The term “content description” indicates that it is not the content itself, but typically some information about what is contained in the medical image and possibly further properties of this object, such as its position, pose, and size. The content description may be based on a classification of what is represented by the medical image. The content description may also contain numerical values, such as for the above mentioned position and size data.

The ability of the mapping component to compare the current content description with one or more stored content descriptions serves mainly to identify stored content descriptions that are identical or similar to the current content description. The underlying assumption is that images that are accompanied by identical or similar content descriptions may be displayed in an identical or similar manner. If the result of the comparison is that none of the stored content descriptions is identical to the current content description, but there are several stored content descriptions that are sufficiently similar to the current content description, then several of these similar content descriptions may be retained for further processing.

Another ability of the mapping component is the retrieval of stored visualisation parameters related to at least one further content description, i.e. the at least one content description that was retained by the selection block/module of the mapping component. The visualisation parameters effect the way how a medical image is displayed to an observer. Examples are brightness and contrast values, colour scheme, magnification factor, and orientation of the image. In the case of three dimensional medical images that are to be displayed on a two dimensional display, also the perspective may belong to the visualisation parameters. The perspective may be described by defining the position of the observer (often referred to as “camera position”) with respect to the represented object.

The ability of the mapping component to prepare the stored visualisation parameters as the visualisation parameters controlling the display of the medical image may be performed by a visualisation parameter module/unit. Preparation of the stored visualisation parameters could be simply reading the visualisation parameters and passing them to an output interface of the mapping component that is connected to a display during operation. Preparation of the stored visualisation parameters could also be more complicated, especially in the case where several sets of visualisation parameters were retrieved. In that case, the retrieved sets of visualisation parameters could be merged by averaging or the like.

The data processing apparatus described above may provide a new functionality for medical viewing workstations: after learning a certain anatomical view (e.g. four chamber view of the human heart), the user can automatically “jump” to these views and display the data in fixed anatomy dependent perspective, using learned contrast or lighting parameters. This new feature will not only simplify the viewing of medical data sets, but it will also enable a better inter-patient comparison of images (slice to slice correspondence) and it will improve the monitoring of pathologies in follow up studies. The data processing apparatus according to the invention provides fully automated adjustment of viewing, perspective, and contrast parameters on medical viewing workstations. When the above mentioned comparison module has identified a data set that is identical or sufficiently similar to the current data set, then retrieval of the visualisation parameters comprises extracting these visualisation parameters from the record containing the identified data set. In the alternative to storing both the data set and the visualisation parameters in the same record, one of them or both may contain references to each other.

The content description of the medical image may comprise landmark data. Typically the landmark data is an anatomical landmark data. Each landmark usually comprises a tag or label that identifies it as the representation of a specific point in the body of the patient. The landmark usually also contains position data (two-dimensional or three-dimensional). Comparison of landmark data maybe achieved by determining a suitable measure of distance between two sets of landmark data (landmark sets). It should be noted that it is usually desirable to use a distance measure that is unaffected by translations, rotations, and the geometrical size of the objects represented by the landmark sets. Accordingly, the comparison usually mainly focuses on the shape of the object represented by the landmark sets.

The data processing apparatus may further comprise a landmark detector arranged to detect landmarks in the medical image and to merge the landmarks into the current data set. The inclusion of the landmark detector into the data processing apparatus further adds to the consistent display of medical images. Landmark detection may be based on shape analysis performed on the content of the medical image. Alternatives are the evaluation of grey-value gradient or boundary detection, to name just a few.

The data processing apparatus may further comprise a user input interface, wherein user input comprises content description of the medical image to be displayed. The content description entered by the user may be a general description of the medical image, such as “four-chamber view of the human heart”. The content description may also be more detailed. For example, the user may point to a certain area within the medical image using a pointing device and assign a tag or label to it. In this manner, anatomical landmarks can be defined by the user. When provided in combination with the previously mentioned landmark detector, the user may add further landmarks or correct the landmarks that were determined by the landmark detector.

The data processing apparatus may further comprise a user feedback component arranged to track adjustments of the visualisation parameters performed by a user, to determine adjusted visualisation parameters and to store the adjusted visualisation parameters. In order to determine the optimal values of the various visualisation parameters, it is possible to analyze how a human user sets the visualisation parameters. It can be reasonably assumed that in most cases the user will end up with a display of the current medical image that meets his/her expectations, for example in terms of informative value. It may be the case that the user adjusts an automatically determined view. In that case, the feedback component is arranged to determine the difference between the automatically determined visualisation parameters and the visualisation parameters entered by the user. The adjusted visualisation parameters may be determined by the feedback component either by simply adopting the visualisation parameters entered by the user or by averaging the automatically determined visualisation parameters and those entered by the user. Storage of the adjusted visualisation parameters facilitates the retrieval later on while preparing another medical image having a similar or identical content description for display. The feedback component may be arranged to support a “learning mode” in which visualisation parameters that are entered by a user are considered while determining adjusted visualisation parameters. The feedback component may also be set to “inactive”. This is useful for situations in which the user simply wishes to watch the medical image using different perspectives, contrast settings and the like, but does not intent to modify the automatically determined visualisation parameters. It may also be envisaged to oblige the user to confirm a modification of the stored visualisation parameters.

The invention also relates to a method of providing visualisation parameters controlling the display of a medical image. This method comprises

receiving a current data set corresponding to the medical image and comprising a content description thereof,

comparing the content description of the current data set with a content description of a plurality of stored data sets,

selecting at least one further data set out of the plurality of stored data sets,

retrieving stored data visualisation parameters corresponding to the at least one further content data set,

preparing the retrieved visualisation parameters as the visualisation parameters controlling the display of the medical image.

The correspondence between a data set and a medical image may be implemented in various ways. Some examples were mentioned above with respect to the data processing apparatus.

Also the term “content description” was already elucidated above.

By comparing the current content description with one or more stored content descriptions an identification of those of the stored content descriptions that are identical or similar to the current content description is made possible. The underlying assumption is that images that are accompanied by identical or similar content descriptions may be displayed in an identical or similar manner. If the result of the comparison is that none of the stored content descriptions is identical to the current content description, but there are several stored content descriptions that are sufficiently similar to the current content description, then several of these similar content descriptions may be retained for further processing.

As a result of the comparison, retrieving of stored visualisation parameters related to the at least one further content description is performed. The at least one further content description is (one of) the content description(s) that was retained by the selection block/module of the mapping component. For examples of visualisation parameters reference is made to comments relating the data processing apparatus.

Preparing the stored visualisation parameters could be achieved by reading the visualisation parameters and passing them on to a display during operation. Preparing the stored visualisation parameters could also be more complicated, especially in the case where several sets of visualisation parameters were retrieved. In that case, the retrieved sets of visualisation parameters could be merged by averaging or the like.

The action of retrieving may comprise querying a database storing records, each record containing one of the stored data sets and the visualisation parameters related thereto.

The query could contain an entire data set or only parts of a data set. The database may then return records that contain matching data sets. Instead of returning the entire record, the data base may return the visualisation parameters, only.

The content description of the medical image may comprise landmark data.

The method may further comprise

detecting landmarks in the medical image and

merging the landmarks into the current data set.

The method may still further comprise

tracking adjustments to the visualisation parameter performed by a user,

determining adjusted visualisation parameters, and

storing the adjusted visualisation parameters.

The invention further relates to a computer programme product having computer-executable instructions on it to cause a processor to carry out the actions of the method as are set forth in the forgoing.

The computer-executable instructions may be implemented in the form of software, notably in the form of software packages that upgrade already installed software to enable installed medical imaging systems and medical viewing stations to also operate according to the present invention.

### BRIEF DESCRIPTION OF THE DRAWINGS

These and other aspects of the invention will be described in further details with reference to figures.

FIG. 1 presents in a schematic way an exemplary application of the present invention.

FIG. 2 presents in a schematic way a second exemplary application of the present invention.

FIG. 3 presents a schematic view of an embodiment of the apparatus according to the invention.

### DETAILED DESCRIPTION OF THE EMBODIMENTS

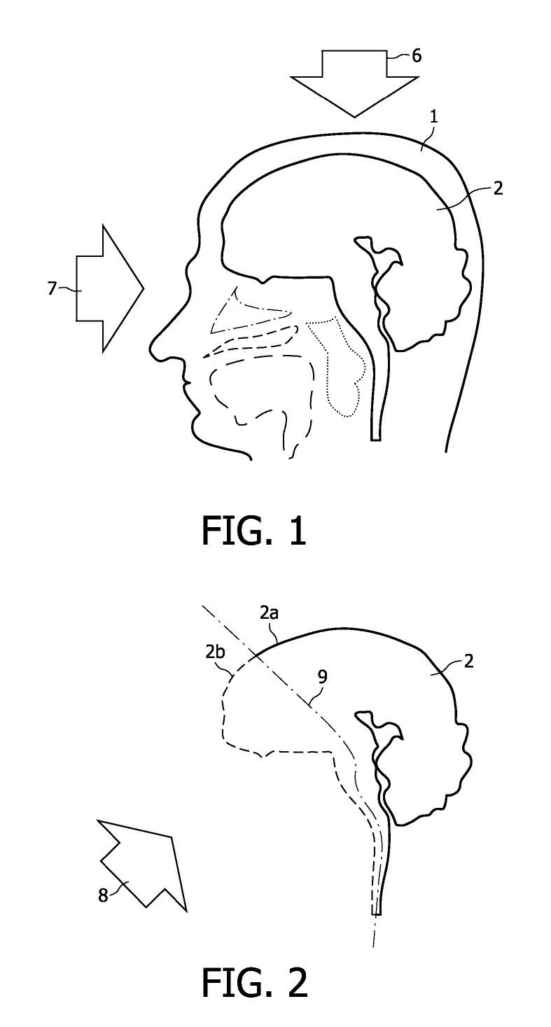

The various aspects of the present invention can be readily understood by first studying an exemplary application. FIG. 1 shows the head 1 of a human patient. The brain 2 and various other anatomical structures within the head of the patient, such as the tongue or the palate are also represented in a schematic manner. Let us assume that a user of the medical imaging modality is mainly interested in visualising the brain 2. The user may be a physician, a radiologist, or another person involved with the acquisition and visualisation of medical images. Let us further assume that a three-dimensional scan of the patient's head is available. Depending on which region of the brain 2 the user desires to exam, he needs to choose an appropriate perspective. Two of several possible perspectives are represented in FIG. 1 by the arrows 6 and 7. Arrow 6 represents a perspective in which the user looks down onto the top of the brain 2. Arrow 7 represents another perspective corresponding to a front view on the brain 2. If the image data containing the brain 2 can be separated from the remaining data, for example by a suitable segmentation performed on the medical image, then the user can look at the brain in a nearly optimal way. This example refers to a three-dimensional medical image, as obtained from e.g. computer tomography or magnetic resonance imaging. However, the invention may be also be applied to two-dimensional medical images. For example, a two-dimensional image may be rotated and scaled in order to show significant parts of the image more clearly. Furthermore the brightness, contrast and colouring scheme of the two-dimensional image may also be modified in order to enhance the image. Masking of (temporarily) irrelevant objects maybe performed on two-dimensional images as well as on three-dimensional images.

FIG. 2 presents another exemplary application of the present invention. Still referring to the image of a brain 2 mentioned in FIG. 1, the user may whish to look at a sectional view of the brain 2, the section surface being represented by line 9 in FIG. 2. Accordingly the representation of the brain 2 is split into two parts, a visible part 2a and an invisible part 2b. The direction in which the user looks at the sectional view of brain 2 is indicated by arrow 8.

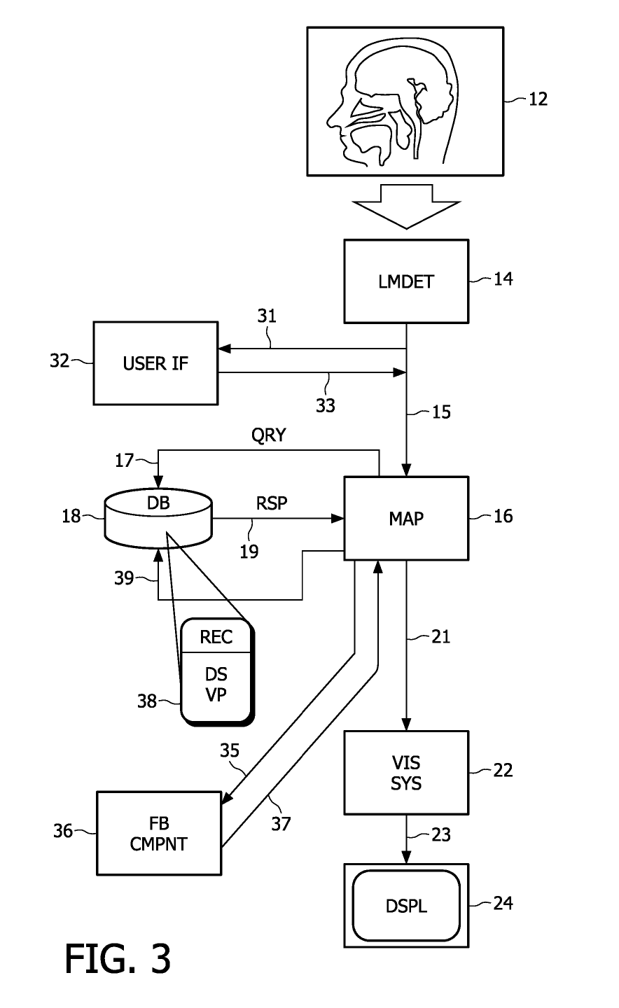

FIG. 3 presents a schematic view of an embodiment of the data processing apparatus according to the invention. A medical image 12 is used as input for a landmark detector 14. Landmark detector 14 analyzes the medical image 12 with respect to anatomical landmarks in the image. In the case of the exemplary image 12 in FIG. 3 such anatomical landmarks could be points of specific anatomical features such as the point of the transition from the brainstem to the brain. However, anatomical landmarks are not restricted to points, but may also be lines, surfaces, or contours. The landmark detector 14 may employ a grey value gradient analysis of the medical image or the deformable shape technology, for example. A landmark detector (LMDET) 14 creates a landmark set 15 of the current medical image 12 containing the results of the landmark detection. At this point, landmark set 15 may be forwarded to a user interface (USER IF) 32 in order to be displayed to a user. The forwarded landmark set bears reference numeral 31. The landmark set 31 may be overlaid to the medical image 12 so as to give the user the opportunity to check whether correct landmarks were determined by the landmark detector 14. User interface 32 may give the user the opportunity to correct misplaced or mislabelled landmarks and also to create/define new landmarks. The creation of new landmarks may be necessary if the landmark detector 14 is not part of the data processing apparatus according to the invention, if it is not programmed to determine landmarks for the given type of the current medical image 12, or if it was not able to do so for another reason. The landmark set 33 corrected or created by the user is returned to the automatically determined landmark set 15.

Landmark set 15 then enters the mapping component 16. Mapping component 16 uses landmark set 15 in order to prepare a query (QRY) 17 that is to be sent to a database (DB) 18. Database 18 contains several records (REC) 38. In the present example, each record contains data set (DS) and visualization parameters (VP). Having processed the query 17, database 18 sends a response (RSP) 19 that contains one or several matching records 38. Standard databases work well with records that can be classified into a number of classes. In the case of medical images an example of a class may be the organ that is represented in the medical image. However, when it comes to landmark data involving e.g. two-dimensional or three-dimensional coordinates, a standard database may not be optimal for determining which of its records are similar to the presented query 17. The reason is that this determination may involve rather complicated calculations. A possible solution is to have the database 18 perform a pre-selection based on a relatively simply query 17 and send the pre-selected records to the mapping component 16 as the response 19.

Mapping component 16 may then determine which of the pre-selected records contains landmark set that are similar or even identical to the current landmark set 15. To this end, mapping component 16 could calculate a distance measure between the current landmark set and each of the pre-selected records' landmark sets. Mapping component 16 then retains one or several records of which the landmark sets are sufficiently close to the current landmark set 15. Mapping component 16 may also retain known record if none of the pre-selected records contained a landmark set that was sufficiently close to the current landmark set 15.

If at least one record was retained by mapping component 16, the visualisation parameters 21 are extracted from this record and passed onto a visualisation system (VIS SYS) 22. The visualisation parameters 21 could also be created by using a combination of several of the pre-selected records, such as an average. At this point, another possible user interaction is represented in FIG. 3 as a feedback component (FB CMPNT) 36. Visualisation parameters 35 are sent to feedback component 36. The feedback component could already display the medical image 12 using the visualisation parameters 35. Feedback component 36 could also display a preview having a lower quality, but being sufficiently precise for a first evaluation of how the medical image will be displayed. If the user is satisfied, he/she may send a command to mapping component 16 telling the mapping component 16 that the suggested visualisation parameters are accepted. In the contrary case, the user may adjust the displayed medical image, for example by changing the perspective or the scaling factor. The modified visualisation parameters are handed back to mapping component 16 which in turn sends them as visualisation parameters 21 to visualisation system 22. Depending on whether a learning mode of the data processing apparatus is activated or not, mapping component 16 may send the corrected visualisation parameters also to data base 18 in a modification message 39. The affected records are then updated with the modifications requested by the user.

The visualisation system 22 uses the visualisation parameters 21 in order to display medical image 12. In the case of a three-dimensional medical image 12 visualisation system 22 might comprise a rendering unit. A rendering unit requires a number of parameters, such as the so called camera position and the illumination (direction and type). The output of visualisation system 22 is send as a signal 23 to a display (DSPL) 24.

By automatically learning and applying viewing, perspective and contrast parameters, the visualisation, comparison and evaluation of medical images will be simplified. In the future, the automated and consistent visualisation of an anatomy will probably overcome the standard slice-by-slice viewing of volumetric images, since the automated viewing will only be dependent on the anatomy and not on the position of the patient in the scanner. Also, for follow-up studies, the evolution of pathology will be easier to perceive since positional variations of a patient are suppressed.

Within and around the invention the following four technologies, among others, are used:
1) a detection system for anatomical landmarks in a given medical image,
2) a visualisation system where users can adjust several perspective, viewing or contrast parameters,
3) a database, where anatomical landmarks and the adjusted viewing parameters are scored, and
4) a mapping system which interpolates the viewing parameters given a set of anatomical landmarks.

The most important application of the described method is the automated adjustment of the viewing, perspective, and contrast parameters on medical viewing workstations. The automated learning of viewing parameters (e.g. viewing plane, contrast or camera perspective) will enable to quickly and reliably view medical images of the same anatomy in a reliable and constant way.

1. A data processing apparatus for providing visualisation parameters controlling the display of a medical image, the data processing apparatus comprising
a mapping component arranged to receive a current dataset corresponding to the medical image and comprising a content description thereof,
to compare the content description of the current dataset with a content description of a plurality of stored datasets,
to select at least one further dataset out of the plurality of stored datasets,
to retrieve stored visualisation parameters corresponding to the at least one further dataset, and
to prepare the retrieved visualisation parameters as the visualisation parameters controlling the display of the medical image.

2. The data processing apparatus according to claim 1, further comprising a database arranged to store records, each record containing one of the stored datasets and the visualisation parameters related thereto.

3. The data processing apparatus according to claim 1, wherein the content description of the medical image comprises landmark data.

4. The data processing apparatus according to claim 3, further comprising a landmark detector arranged to detect landmarks in the medical image and to merge the landmarks into the current dataset.

5. The data processing apparatus according to claim 1, further comprising a user input interface, wherein user input comprises content description of the medical image to be displayed.

6. The data processing apparatus according to claim 1, further comprising a user feedback component arranged to track adjustments of the visualisation parameters performed by a user, to determine adjusted visualisation parameters, and to store the adjusted visualisation parameters.

7. A method of providing visualisation parameters controlling the display of a medical image, the method comprising
receiving a current dataset corresponding to the medical image and comprising a content description thereof,
comparing the content description of the current dataset with a content description of a plurality of stored datasets,
selecting at least one further dataset out of the plurality of stored datasets,
retrieving stored visualisation parameters corresponding to the at least one further content dataset,
preparing the retrieved visualisation parameters as the visualisation parameters controlling the display of the medical image.

8. The method according to claim 7, wherein said retrieving comprises querying a database storing records, each record containing one of the stored datasets and the visualisation parameters related thereto.

9. The method according to claim 7, wherein the content description of the medical image comprises landmark data.

10. The method according to claim 9, further comprising
detecting landmarks in the medical image and
merging the landmarks into the current dataset.

11. The method according to claim 7, further comprising
tracking adjustments to the visualisation parameters performed by a user,
determining adjusted visualisation parameters, and
storing the adjusted visualisation parameters.

12. A computer programme product having computer-executable instructions on it to cause a processor to perform the method according to claim 7.
